(19) United States
(12) Patent Application Publication
(10) Pub. No.: US 2025/0202210 A1
(43) Pub. Date: Jun. 19, 2025

(54) GROUNDING JUNCTION BOX

(71) Applicant: Pegasus Solar Inc, Richmond, CA (US)

(72) Inventors: Erich Kai Stephan, Richmond, CA (US); Ian Wogan, Richmond, CA (US); Brady Miramontes, Richmond, CA (US); James Hsieh, Richmond, CA (US)

(21) Appl. No.: 18/988,640

(22) Filed: Dec. 19, 2024

Related U.S. Application Data
(60) Provisional application No. 63/612,312, filed on Dec. 19, 2023.

(51) Int. Cl. H02G 3/08

(52) U.S. Cl. CPC H02G 3/081

(57) ABSTRACT

Systems for grounding junction box are provided, as well as methods for installing the systems. An exemplary grounding junction box may include a housing, a grounding bar affixed to the housing and including a first end and a second end, at least one ground lug mounted within the enclosure of the housing, and a rail lock mounted to the second end of the grounding bar. The housing comprises a base wall, at least one side wall extending from the base wall, and a lid attached to the at least one side wall, forming an enclosure when closed. The at least one ground lug electrically connects the grounding bar and includes a wire guide receiving and securing a grounding wire with a ground lug fastener. The rail lock is configured to secure the grounding bar to a rail and form an electrical bond path from the grounding wire to the rail.

### CROSS-REFERENCE TO RELATED APPLICATION

The present application claims the priority benefit of U.S. Provisional Patent Application No. 63/612,312 filed on Dec. 19, 2023, the disclosure of which is incorporated herein by reference in its entirety.

### BACKGROUND OF THE INVENTION

Current rooftop solar arrays may have electrical wires that are required to be connected to one another in a weatherproof enclosure. Often, a metal mounting hardware in the enclosure needs to be electrically bonded to a conduit or a ground wire inside of the enclosure. Current systems require a wire to be connected and routed from the metal mounting hardware into the enclosure and connected to a grounding wire. The present invention eliminates the need for this additional wire by providing a bond path from the metal mounting equipment inside the enclosure for accepting a grounding wire.

### SUMMARY OF THE CLAIMED INVENTION

Embodiments of the present technology include systems for grounding junction box for a rail-supported solar panel array, as well as methods for installing the grounding junction box systems. An exemplary grounding junction box for a rail-supported solar panel array may include a housing, a grounding bar affixed to the housing and including a first end and a second end, at least one ground lug mounted within the enclosure of the housing, and a rail lock mounted to the second end of the grounding bar. The housing may comprise a base wall, at least one side wall extending from the base wall, and a lid configured to attach to the at least one side wall and to adjust between an open position and a closed position. The lid forms an enclosure when the lid is in the closed position. The at least one ground lug is electrically connected to the first end of the grounding bar and includes a wire guide configured to receive and to releasably secure a grounding wire by engaging with a ground lug fastener. The rail lock is configured to secure the second end of the grounding bar to a rail so as to form an electrical bond path extending from the grounding wire through the at least one ground lug and the grounding bar to the rail.

In some examples, a method for installing grounding junction boxes includes attaching a grounding junction box to a rail. The grounding junction box includes a housing, a grounding bar, at least one ground lug, and a rail lock. The method includes electrically bonding the at least one ground lug within the grounding junction box to the grounding bar using a ground lug fastener. The grounding bar is electrically bonded to the rail. The method includes passing a grounding wire into the grounding junction box. The method includes securing the grounding wire onto the at least one ground lug with the ground lug fastener.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1A depicts an isometric view of an exemplary grounding junction box, with a lid in an open position.

FIGS. 1B-C depict an isometric view and a side view of an exemplary grounding junction box, with a lid in a closed position.

FIGS. 2A-B depict isometric cross-sectional views of an exemplary grounding junction box with a lid in an open position and a closed position, respectively.

FIGS. 3A-B depict a top isometric view and an underside isometric view of an exemplary ground bar assembly.

FIGS. 4A-B depict a top view and an underside view of an exemplary grounding junction box in a closed position.

FIG. 4C depicts a top view of an exemplary grounding junction box without a lid.

FIG. 4D depicts a closed-up side view of an exemplary hinge.

FIGS. 5A-B depict isometric views of an exemplary grounding junction box installed onto a first rail connected to a second rail by a rail splice.

FIG. 5C depicts an isometric cross-sectional view of an exemplary grounding junction box installed on a rail at a location without a rail splice within the rail.

FIG. 5D depicts a side view of an exemplary grounding junction box installed onto a rail with a rail splice within the rail.

FIG. 5E depicts a side view of an exemplary grounding junction box with a lid in an open position, installed onto rail with no rail splice installed in the rail.

FIG. 6A depicts an isometric view of an exemplary junction box with a flexible lid lock, with a lid in a closed position.

FIG. 6B depicts an isometric view of an exemplary junction box with a flexible lid lock, with a lid in an open position.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

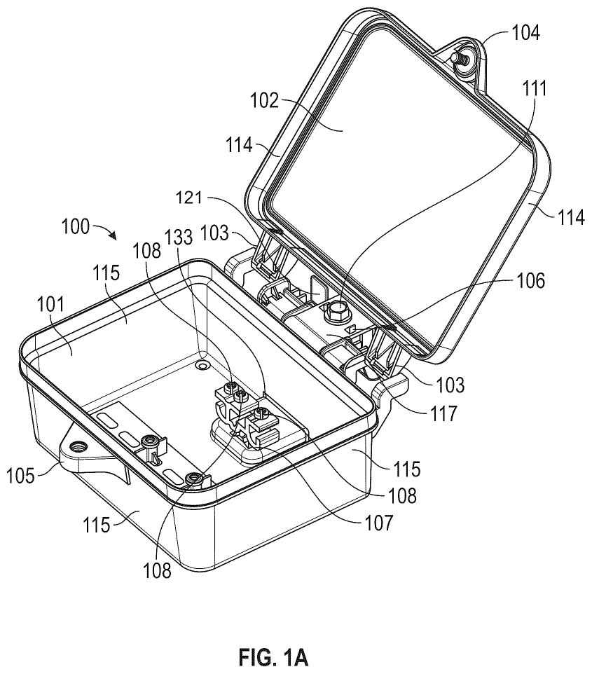

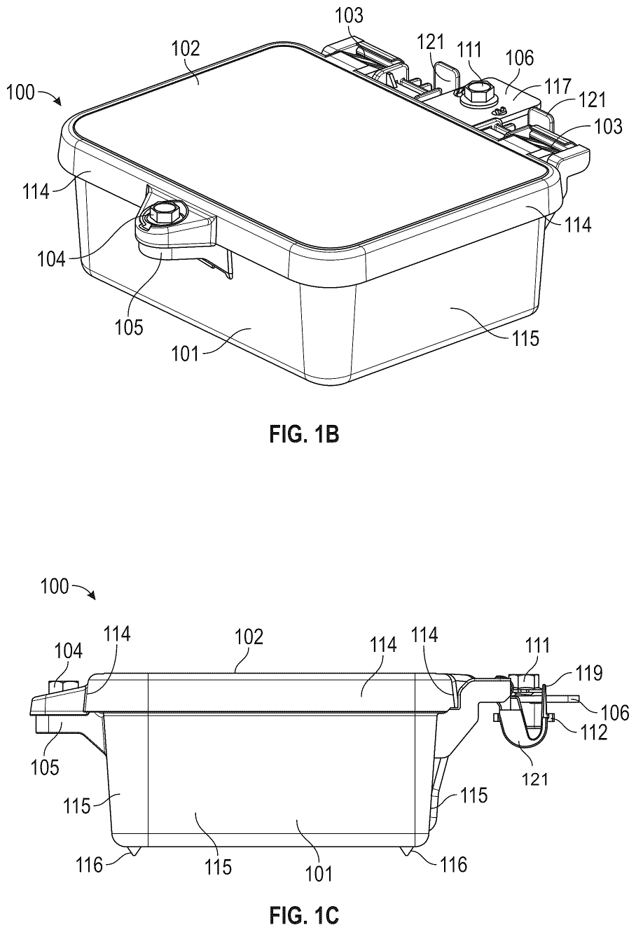

FIG. 1A depicts an isometric view of an exemplary junction box, with a lid in an open position. The grounding junction box 100 may comprise a bucket 101 (or hereinafter, the bucket 101 can alternatively be referred to as housing), a lid 102 and a ground bar assembly 117. The lid 102 may be configured to attach to at least one side wall of the bucket 101 by a hinge 103, and the lid 102 may be adjusted between an open position and a closed position. For example, the lid 102 can rotate around an axis of the hinge 103 from a closed position to an open position. In the closed position, the top surface of the lid 102 may be substantially parallel with the base wall of the bucket 101 and lid lip 114 may extend below the top rim of the bucket 101. In the same closed position, the lid can form an enclosure in conjunction with the housing.

FIGS. 1B-C depict an isometric view and a side view of an exemplary grounding junction box, with a lid in a closed position. In some example embodiments, when the lid 102 is in a closed position, the cavity inside the bucket 101 is sealed from external intrusions (e.g., liquid and/or debris). In other example embodiments, a closed position may prevent readily accessing the inside of bucket 101, such as by a tool, a person, a debris, rain, or other foreign objects. The lid 102 may have a lid lip 114 disposed around the perimeter of the lid 102 and configured to extend below the distal rim of the bucket 101 in order to prevent liquid or debris from accessing the interior cavity of the bucket 101. In some example embodiments, a gasket may be disposed on the inside of lid 102 and configured to sit on, seal, or coincide with the top rim edge of one or more side walls 115 of the bucket. On an opposite or adjacent side of lid 102 from hinge 103, one or more lid locks 104 may be disposed. As depicted, lid lock 104 may be a fastener (e.g., a threaded fastener) configured on the lid 102 to engage with a threaded aperture within a bucket lock 105 disposed on or extending from the outside surface of the at least one side wall 115 of the bucket 101.

In some examples, one or more rail lock tabs 121 may be disposed on the side walls 115 (as shown in FIG. 1B) and configured to substantially align with rail lock nut 112 (as shown in FIG. 1C). A rail lock tab 121 may have a substantially U-shaped profile configured to slide into a rail 200 with one or more engagement barbs configured to retain the grounding junction box 100 to the rail 200 before a rail lock nut 112 has been engaged with rail 200. In some examples, the rail lock tab 121 can comprise a resilient flexible release tab 119 configured to flex as the grounding junction box 100 is installed onto the rail 200 and to spring into a nominal position so the engagement barbs engage with the rail 200 to secure the grounding junction box 100 to the rail 200. The resilient flexible release tab 119 may have a surface configured to press the tab using a thumb or a finger in order to release the engagement tabs for removing or uninstalling the grounding junction box 100 from the rail 200. In this manner, the grounding junction box 100 is operable to be demounted from the rail 200.

In some examples, the one or more side walls 115 may extend from the base wall, disposed at an angle (e.g., an obtuse angle) relative to the base wall of the bucket 101 as shown in FIG. 1C. The lid lip 114 may be disposed at an obtuse angle with the top surface of lid 102. In some examples, bucket feet 116 may be disposed on the underside surface of bucket 101 also as shown in FIG. 1C. In some examples, the bucket feet 116 may be a triangular, a trapezoidal, a cone, a rounded, or a semi-spherical shape, configured to prevent grounding junction box 100 from readily sliding off of a roof surface. In some examples, the bucket feet 116 may be disposed at four points, with one foot at each corner of the underside of the bucket 101, or may be a plurality of points disposed across the entire underside surface of the bucket 101 (e.g., forming a texture pattern). In some examples, each point of the bucket feet 116 may be sharp enough to nestle between granules of a composition shingle but not so sharp as to easily puncture or harm a human hand. In some examples, the bucket 101 may have four side walls 115, and one or more of these side walls may be at an obtuse angle relative to the base wall of the bucket 101. The lid lip 114 may be at an obtuse angle with the top surface of lid 102.

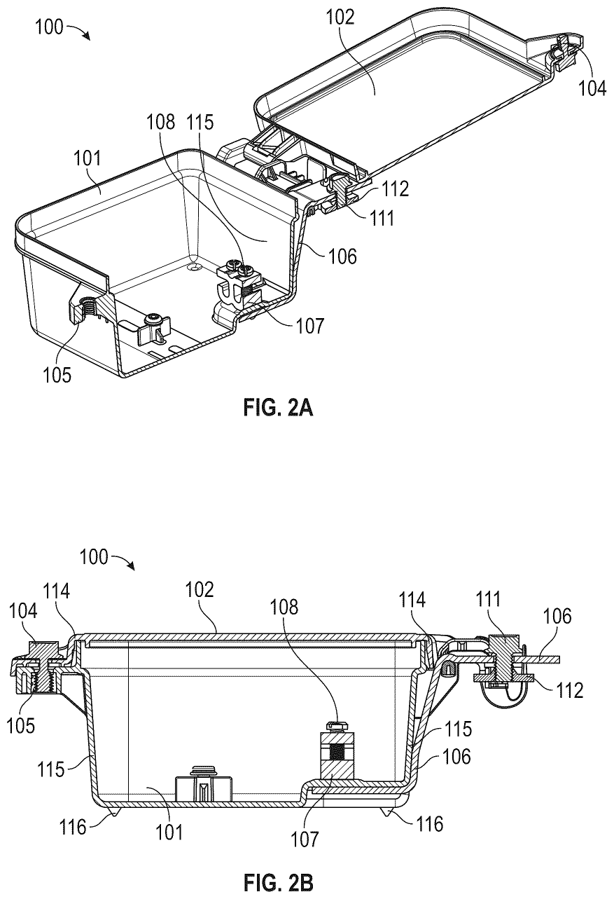

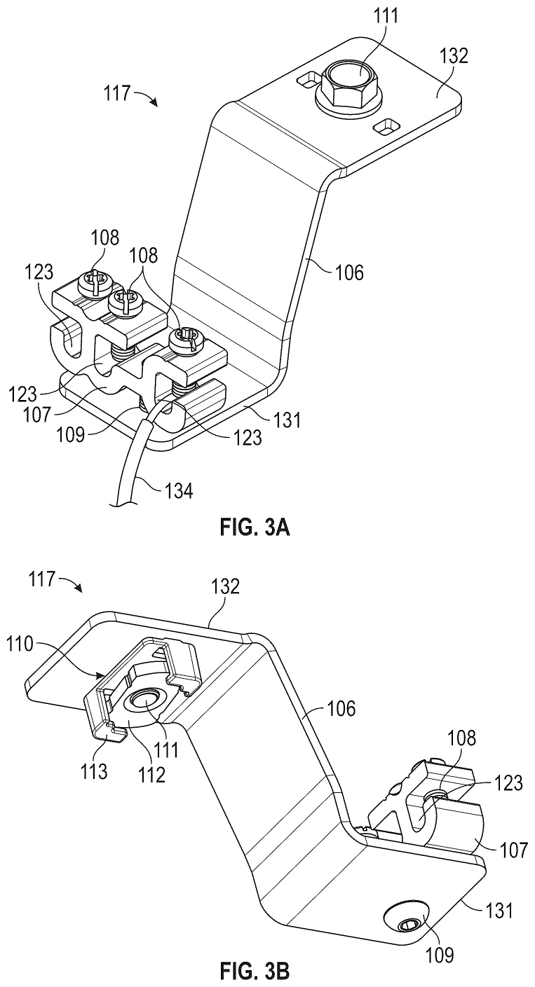

FIGS. 2A-B depict isometric cross-sectional views of an exemplary grounding junction box 100 with a lid 102 in an open position (FIG. 2A) and a closed position (FIG. 2B), respectively. In this exemplary embodiment, the grounding junction box comprises at least the bucket 101, the lid 102, and a ground bar assembly 117. In some examples, the ground bar assembly 117 may comprise a grounding bar 106, a ground lug 107, a ground lug fastener 108, a ground lug securement fastener 109 (illustrated at least in FIGS. 3A-B and further described in corresponding descriptions below), a rail lock 110, a rail lock fastener 111, a rail lock nut 112, and a rail lock nut retention clip 113 (illustrated at least in FIG. 3B and further described in corresponding descriptions below).

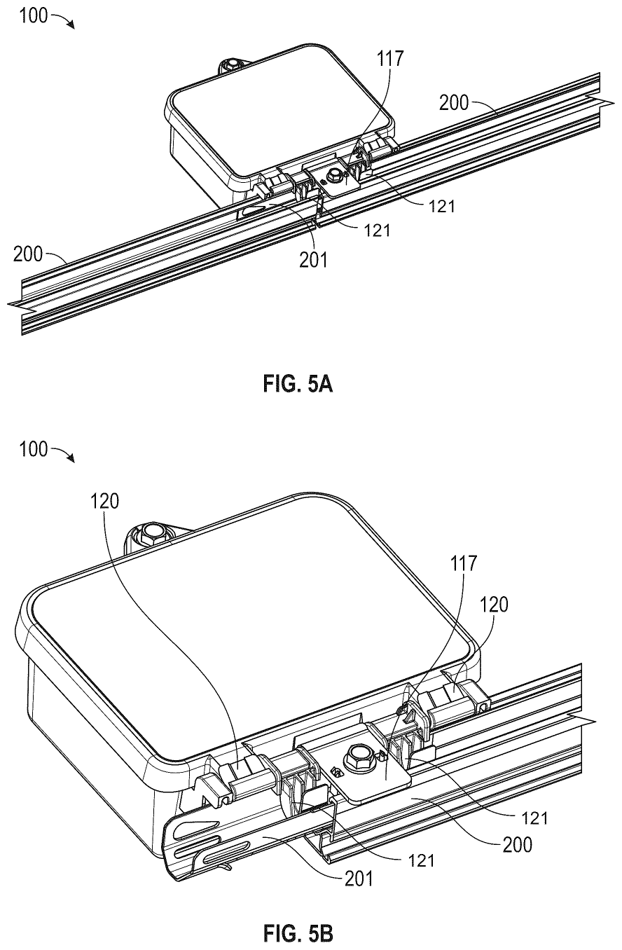

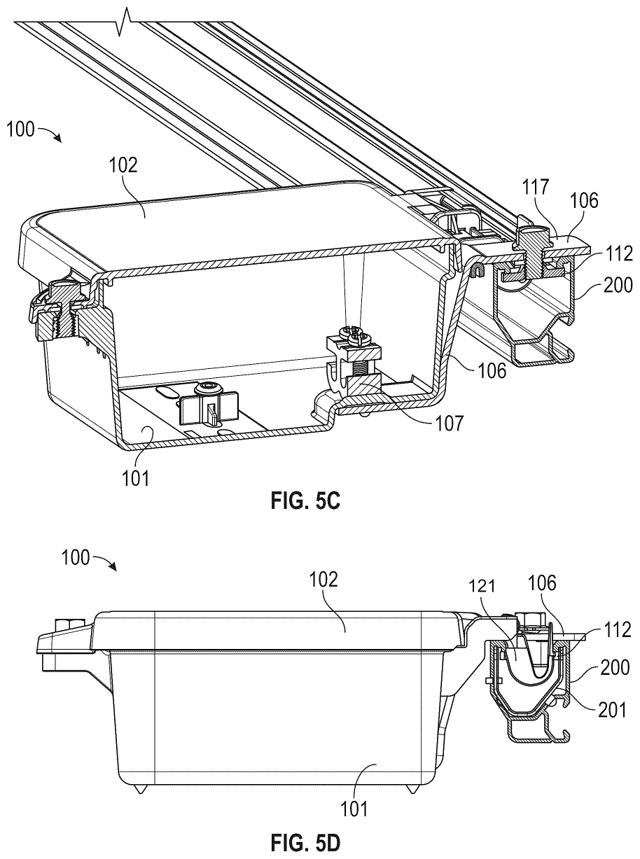

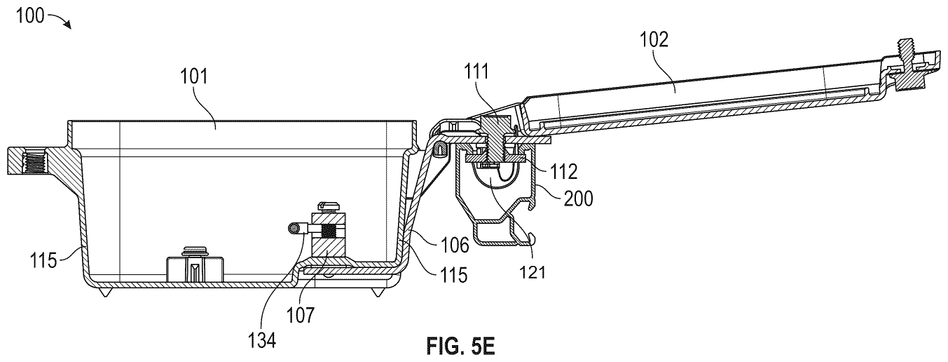

FIGS. 3A-B depict a top isometric view and an underside isometric view of an exemplary ground bar assembly. In an exemplary embodiment, the ground bar assembly 117 may comprise a grounding bar 106, a ground lug 107, at least one ground lug fastener 108, a ground lug securement fastener 109, a rail lock 110, a rail lock fastener 111, a rail lock nut 112, and a rail lock nut retention clip 113. In some examples, the rail lock 110 is mounted to the second end (e.g., second flange 132) of the grounding bar. The rail lock 110 can be configured to secure the second end to ta rail in order to form an electrical bond path, which extends from a grounding wire 134 through one or more ground lugs, then to the grounding bar, and finally to the rail. An illustration of such a connection that form the electrical bond path is shown at least in FIG. 5E.

In some examples, the rail lock 110 includes a lock nut (e.g., a rail lock nut 112) rotatably mounted to the second end (e.g., second flange 132) of the grounding bar 106. The lock nut is able to make an entry through an opening of the rail 200 in the top surface of the rail 200 and to the inside of the rail 200. When entering the rail through the opening of the rail 200, the lock nut is in a first position (e.g., elongated length of the rail lock nut 112 is in parallel with the rail 200). Once entered, the lock nut (e.g., a rail lock nut 112) can be adjusted to be in a second position (e.g., a rail lock nut 112 having its elongated length positioned perpendicular to the rail) in order to prevent the lock nut from escaping the interior of the rail 200 through the opening of the rail 200.

In one example, the grounding bar 106 may be formed to have a first end (e.g., a first flange 131, or in other words, an inner flange) on one end of the grounding bar, by which to mount the grounding bar 106 to the bucket 101 of the grounding junction box 100 to have the grounding bar 106 affixed to the housing (e.g., at the base wall of the housing), and a second end (e.g., a second flange 132) at the other end of the grounding bar 106 for securement of the grounding bar 106 to the rail 200 (as illustrated at least in FIG. 5A). The first flange 131 may be configured to coincide with (i.e., to mount to) one or more exterior surfaces of bucket 101, such as a the bottom surface of the base wall and/or exterior surface of one or more side walls 115. In another example, the first flange 131 may be mounted to an interior surface of the bucket 101 (as shown in FIG. 1A), such that the first flange 131 resides inside the bucket 101. In these examples, the electrically conductive ground lug securement fastener 109 may mechanically secure by passing through an aperture located at least at the base wall, or at least one side wall 115 of the housing when the lid 102 is closed (therefore forming an enclosure), and electrically bond the ground lug 107 to grounding bar 106 to have the ground lug electrically connected to the first end (e.g., first flange 131) of the grounding bar. In an exemplary embodiment, such as that shown in FIG. 1A, the grounding bar 106 can penetrate one of the side walls of the bucket 101, and such penetration may be achieved through a slot-shaped aperture 133 (shown in FIG. 1A) such that the first flange 131 is positioned on and secured to a bottom or side surface inside the bucket 101 while the second flange 132 resides outside the bucket. Whether the grounding bar 106 resides entirely outside the bucket or penetrates the side wall 115 to place the first flange 131 inside the bucket 101 and the second flange 132 outside, ground lug securement fastener 109 and the aperture through which ground lug securement fastener 109 extends can be sealed using glue, butyl, heat weldment, sealant, caulking, or other suitable methods. Likewise, in embodiments where the ground lug 107 extends through the side wall 115 with the first flange 131 inside the bucket 101 and the second flange 132 outside the bucket, a seal between the inner edges of the slot-shaped aperture 133 and the grounding bar 106 may likewise be formed using glue, butyl, heat weldment, a sealant, caulking, or other suitable methods. In some examples, one or more ground lugs 107 can be mounted within the enclosure of the housing. For example, a plurality of ground lugs 107 can be comprised of at least one, or one or more ground lugs 107. In some examples, at least one ground lug 107 is mounted directly to the grounding bar 106.

In some examples, the ground lug 107 may have one or more wire guides 123, (as shown in FIG. 1A and further shown in FIGS. 3A and 3B), configured to receive and releasably secure electrical wires, including a grounding wire, by one or more ground lug fasteners 108 that enter the grounding junction box 100 to be grounded. These wire guides 123 may be grooves, apertures, slots, channels, or similar features configured to cradle or hold a wire, such as an electrical bonding wire or a grounding wire 134. In an exemplary embodiment, the wire guides 123 can be grooves formed in the ground lugs 107.

In some examples, at least one ground lug fastener 108 is a threaded fastener operable to compress a grounding wire 134 against the wire guide 123 (e.g., against the groove). In some examples, one or more ground lug fasteners 108 may be positioned over the one or more ground lug wire guides 123 (e.g., grooves) and configured to threadedly engage with an aperture disposed in the ground lug 107. When a ground lug fastener 108 threadedly engages with a ground lug 107, the ground lug fastener 108 may press an electrical bonding or grounding wire 134 against the wire guide 123 of the ground lug 107 in order to make an electrical bond path between the grounding wire 134 and the ground lug 107. While bonding or grounding wires 134 of any diameter can be used in this invention, exemplary wires (e.g., grounding wires) can have substantially about 2.5 to 4.2 millimeters of diameters, with the wire guides 123 designed to accommodate the wire diameter chosen. Likewise, any electrically conductive wire material may be used. For example, the electrically conductive wire material can be copper. On the opposite end of the grounding bar 106 from ground lug 107 (i.e., on the second flange 132 of the grounding bar 106), a rail lock nut 112 (as shown in FIG. 3B) may be connected to the grounding bar 106 with a rail lock fastener 111.

In some examples, the rail lock nut 112 may have one or more sharp edges, such as a barb, configured to pierce a coating of rail 200 and thereby create an electrical bond path between rail 200 and rail lock nut 112 when rail lock fastener 111 is tightened onto rail lock nut 112 (e.g., the rail lock fastener 111 is configured to force the rail lock nut 112 toward the second end of the grounding bar 106). Rail lock nut 112 may be made of a material with a higher hardness than the coating on the rail 200, or rail lock nut 112 may have a separately assembled bonding component, such as a pin, attached to or formed onto the main body of rail lock nut 112, wherein that bonding component is configured to pierce a coating on the rail 200. In other example embodiments, the rail 200 may not have a coating and rail lock nut 112 may electrically bond to the rail 200 simply upon contact with the rail. In all configurations, when the grounding junction box 100 is installed onto a rail 200, an electrical bond path is created from the rail 200 through the ground lug 107 and ultimately to the electrical bonding grounding wire 134 through the ground bar assembly 117.

In some examples, a ground lug 107 can be manufactured out of aluminum, copper, stainless steel, zinc, or zinc alloy. In some examples, the ground lug 107 may be made using an extrusion process, to achieve a uniform cross-sectional shape along the length of the wire guides 123. In other example embodiments, ground lug 107 may be made from a casting process wherein the cross-sectional shape tapers along the length of each wire guide 123. In this example embodiment, the cross section may taper from a first edge of ground lug 107 or may taper from a parting line located at a location between a first edge and second edge of a ground lug 107. In some examples, one or more surfaces on a ground lug 107 may be configured to couple with an inside surface of bucket 101 in order to prevent ground lug 107 from substantially rotating around the axis of a ground lug securement fastener 109. In some examples, a ground lug 107 can also be made from a uniform thickness sheet of metal, such as sheet metal, and formed to have one or more wire guides (clamping surfaces) for one or more grounding wires.

In some examples, a grounding bar 106 can be manufactured from a substantially uniform thickness sheet of metal, such as aluminum, stainless steel, or steel. In other examples, grounding bar 106 can have a substantially uniform cross section along its width, as if it were made by using an aluminum extrusion process. In some examples, one or more apertures may be disposed in the surface of the grounding bar 106 in order to receive one or more ground lug securement fasteners 109, rail locks 110, and one or more rail lock fasteners 111. In some examples, grounding bar 106 can have no coating, or it can have a coating to provide a different color or surface protection. One example of a coating material is zinc.

In some examples, rail lock nut retention clip 113 (shown in FIG. 3B) can be configured to prevent rail lock nut 112 from rotating around the primary axis of rail lock fastener 111 until a defined amount of torque is applied to rail lock fastener 111. Rail lock nut retention clip 113 can hold or retain rail lock nut 112 in a non-perpendicular position relative to the length of rail 200 so that rail lock nut 112 can readily enter the top opening of a channel in the top of rail 200 when grounding junction box 100 is being installed onto rail 200. Upon a sufficient amount of torque being applied to rail lock fastener 111, such as from a drill or a similar fastening tool, rail lock nut 112 can flex retention flanges in rail lock nut retention clip 113 to allow rail lock nut 112 to rotate to a substantially perpendicular position relative to the length of rail 200 (as illustrated at least in FIG. 5E), thereby allowing rail lock nut 112 to clamp onto inwardly protruding flanges disposed on the top distal edges of the side walls of rail 200. In some examples, rail lock nut retention clip 113 may have one or more barbs configured to attach to one or more apertures disposed in the surface of grounding bar 106.

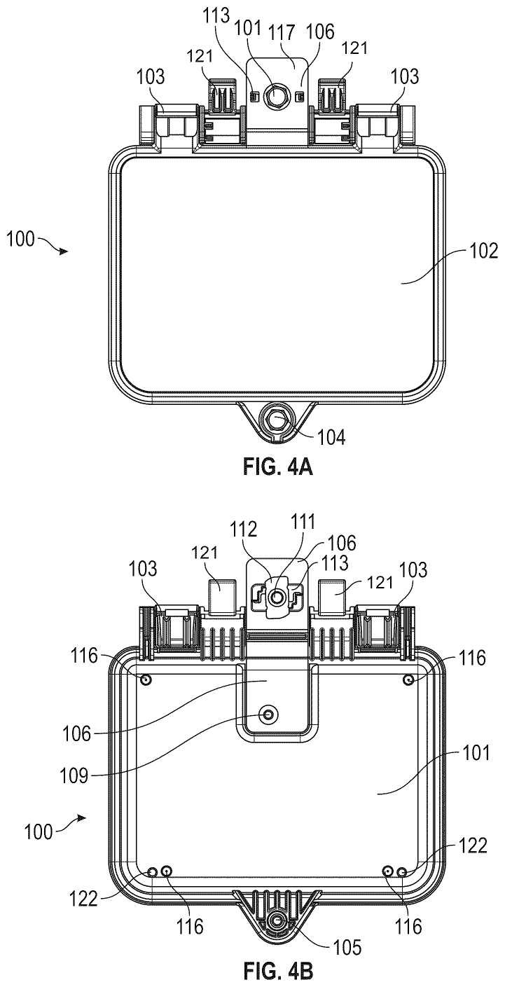

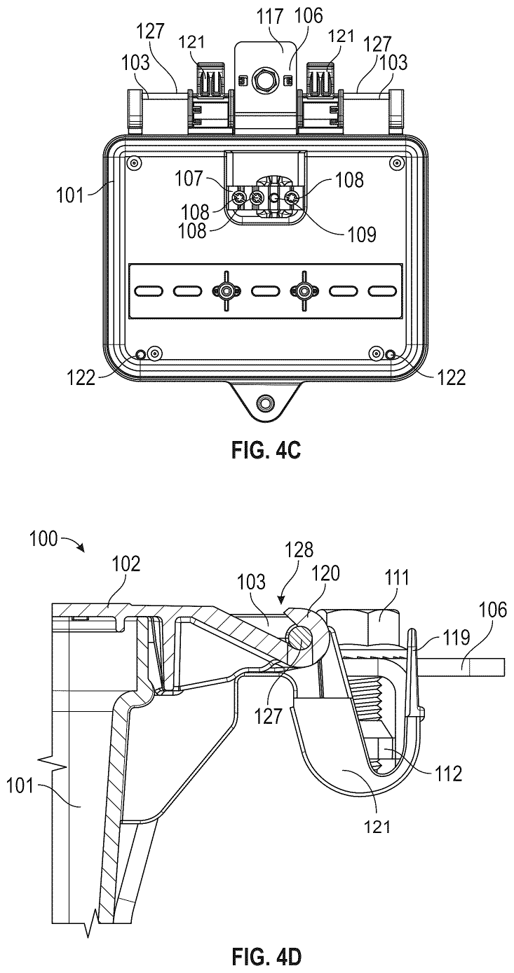

FIGS. 4A-B depict a top view and an underside view of an exemplary grounding junction box 100 in a closed position. FIG. 4C depicts a top view of an exemplary grounding junction box 100 without a lid 102. As illustrated in FIG. 4C, the base wall of the bucket 101 can have one or more drain holes 122 when external intrusions (e.g., liquid and/or debris) intrude the bucket 101. In some examples, the drain holes 122 are disposed at the edge of the base wall of the bucket 101 near one of the side walls 115 that has a bucket lock 105 disposed on the outside surface of the bucket 101. FIG. 4D depicts a closed-up side view of an exemplary hinge 103. In some examples, a pin 127 may function as an axis point for opening and closing the lid 102. As illustrated in FIG. 4D, a bearing flange 120 may be formed in a U-shape for capturing the pin 127. The opening of the “U” may be angled away from the vertical, such as the example shown where the “U” shape is angled at approximately 315 degrees from the vertical. Bearing flange 120 thereby captures and prevents the pin 127 from disengaging vertically when lid 102 is fully closed, or the bearing flange 120 can be rotated 180 degrees to have the lid 102 in an open position. In some examples, as weight is applied to the lid 102 when in an open position, such as from a weight of a tool, bearing flange 120 can secure lid 102 to pin 127.

In some examples, the hinge 103 can comprise a pin 127 formed between one or more flanges configured to rotatably cooperate with a bearing flange 120, as illustrated at least in FIG. 4D. Bearing flange 120 can be disposed on the lid 102 with the pin 127 connected to the bucket 101, or vice versa. Bearing flange 120 can be U-shaped, wherein the inside curve is substantially concentric with the pin, or it may be a series of prongs to allow lid 102 to rotate around the axis of one or more pins 127. In some examples, the bearing flange 120 can terminate with a resilient flexible hinge barb 128 that prevents bearing flange 120 from traversing off of pin 127 after lid 102 is installed to bucket 101. The resilient flexible hinge barb 128 may be pressed to flex away from pin 127 in order to remove lid 102 from bucket 101.

FIGS. 5A-B depict isometric views of an exemplary grounding junction box installed onto a first rail connected to a second rail by a rail splice. As depicted, ground bar assembly 117 is positioned over rail splice 201 and a first rail 200. FIG. 5C depicts an isometric cross-sectional view of an exemplary grounding junction box installed on a rail at a location without a rail splice within the rail. FIG. 5D depicts a side view of an exemplary grounding junction box installed onto a rail with a rail splice within the rail. FIG. 5E depicts a side view of an exemplary grounding junction box with a lid in an open position, installed onto rail with no rail splice installed in the rail. In some examples, the grounding junction box 100 can be installed onto rail 200 regardless of whether a rail splice 201 is disposed in rail 200 at the location where the grounding junction box 100 is installed. In other words, rail lock tabs 121 and rail lock nut 112 are configured to avoid interference should rail splice 201 be present within rail 200 at the installation location of grounding junction box 100.

In other example embodiments, rail splice 201 can be configured to attach externally to rail 200 and may be configured with ample clearance to allow the grounding junction box 100 to be installed over the rail splice 201. In some examples, rail 200 may have a substantially U-shaped profile, and may have a hollow chamber in a lower section. In other example embodiments, rail 200 does not have any hollow chambers but can still be substantially U-shaped. Electrical wires emanating from a solar panel array may thus be grounded to a rail by way of the grounding junction box of the present invention.

In some examples, a method for installing the grounding junction box 100 includes attaching the grounding junction box 100 to the rail 200. The method includes electrically bonding the ground lugs 107 (e.g., at least one ground lug 107) in the grounding junction box 100 to the grounding bar 106 using a fastener (e.g., ground lug fastener), and from the grounding bar to the rail, which can be achieved by at least one fastener (e.g., rail lock fastener 111). The method includes passing or inserting the electrical wires (e.g., grounding wire) into the grounding junction box 100. The method includes securing the inserted wire (e.g., grounding wire) ends on the ground lugs 107 using the ground lug fasteners 108. In an exemplary method for installing the grounding junction box 100, the rail 200 may be secured to an installation surface using one or more attachment brackets or mounts known to those skilled in the art.

In some examples, two rails 200 can be connected and electrically bonded using a rail splice 201. In this example, the grounding junction box 100 can be positioned over rail 200, and one or more rail lock tabs 121 may engage with rail 200 in order to hold grounding junction box 100 in place. Rail lock fastener 111 may be rotated to threadedly engage with rail lock nut 112, thereby clamping grounding bar 106 to rail 200 and creating an electrical bond path to ground lug 107.

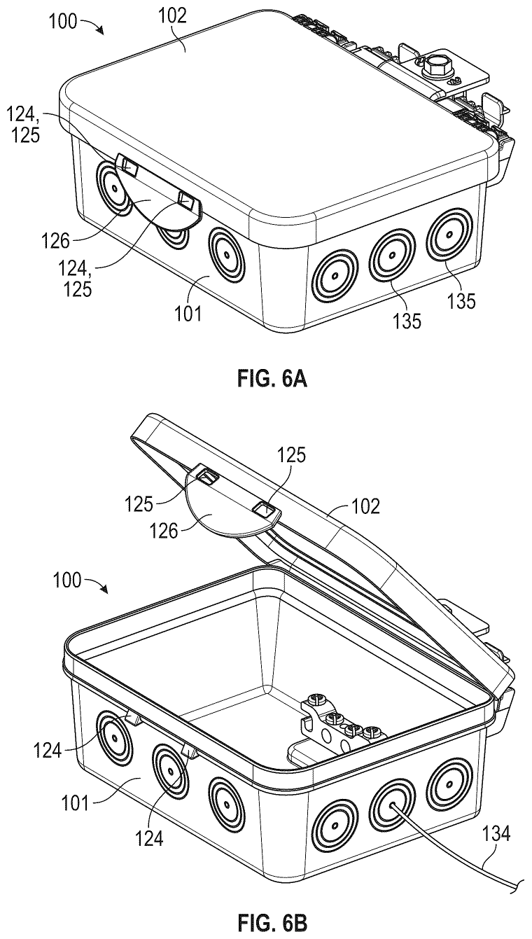

FIG. 6A depicts an isometric view of an exemplary junction box with a flexible lid lock, with a lid 102 in a closed position. FIG. 6B depicts an isometric view of an exemplary junction box with a flexible lid lock, with the lid 102 in an open position.

In some example embodiments, a lid lock 104 may be a lid lock flange 126 (e.g., a flexible lid lock flange) with a lid lock tab 124 configured to engage with one or more apertures (e.g., lid lock apertures 125) disposed on one or more side walls 115. In such an example embodiment, lid lock flange 126 may extend from an edge of the lid 102 and may be flexed a distance to disengage the aperture included in the lid lock flange 126, from the lid lock tab 124, thereby allowing the aperture 125 to be clear of one or more lid lock tabs 124 that are extending from the at least one side wall 115 and enabling lid 102 to lift open and expose the inside cavity of bucket 101.

In some example embodiments, one or more electrical conduit pipes may be connected to the grounding junction box 100 through pipe supports 135, which may be wall inserts, in one or more side walls 115, and a grounding wire routed into the grounding junction box 100 through such a pipe support 135, with the inner end of the wire secured to a ground lug 107 using a ground lug fastener 108. The pipe supports may be selected or configured to accommodate an array of wires of different gauges. Upon completing the of electrical connections of all relevant wires, lid 102 may be closed and secured with lid lock 104 or lid lock flange 126. In some examples, the lid lock 104 can hold the lid 102 in the closed position to allow the lid 102 to form an enclosure and prevent external intrusions from entering the bucket 101 (e.g., the enclosure is waterproof when the lid lock 104 holds the lid 102 in the closed position).

What is claimed is:

1. A grounding junction box for a rail-supported solar panel array, the grounding junction box comprising:
a housing comprising:
a base wall,
at least one side wall extending from the base wall, and
a lid configured to attach to the at least one side wall and to adjust between an open position and a closed position, wherein the lid forms an enclosure when the lid is in the closed position;
a grounding bar affixed to the housing and including a first end and a second end;
at least one ground lug mounted within the enclosure of the housing, wherein the at least one ground lug is electrically connected to the first end of the grounding bar and includes a wire guide configured to receive and to releasably secure a grounding wire by engaging with a ground lug fastener; and
a rail lock mounted to the second end of the grounding bar, the rail lock configured to secure the second end of the grounding bar to a rail so as to form an electrical bond path extending from the grounding wire through the at least one ground lug and the grounding bar to the rail.

2. The grounding junction box of claim 1, wherein the at least one ground lug comprises a plurality of ground lugs.

3. The grounding junction box of claim 1, further comprising an electrically conductive fastener that passes through an aperture at the enclosure to mechanically secure and electrically bond the at least one ground lug to the grounding bar.

4. The grounding junction box of claim 3, wherein the at least one ground lug is mounted directly to the grounding bar.

5. The grounding junction box of claim 3, wherein the first end of the grounding bar is affixed to the base wall.

6. The grounding junction box of claim 1, wherein the first end of the grounding bar is affixed to the base wall.

7. The grounding junction box of claim 1, wherein the wire guide is a groove in the at least one ground lug, and wherein the ground lug fastener is a threaded fastener that compresses the grounding wire against the groove.

8. The grounding junction box of claim 1, wherein the rail lock includes a lock nut rotatably mounted to the second end of the grounding bar and able to enter through an opening in a top surface of the rail and into an interior of the rail while the lock nut is in a first position parallel to the rail, and wherein the lock nut is prevented from escaping the interior of the rail through the opening when the lock nut is adjusted to a second position perpendicular to the rail after entry into the interior.

9. The grounding junction box of claim 8, further comprising a rail lock fastener configured to force the lock nut toward the second end of the grounding bar so as to secure the grounding bar against the rail.

10. The grounding junction box of claim 1, wherein the lid is attached to the at least one side wall by a hinge.

11. The grounding junction box of claim 1, further comprising a lid lock configured to hold the lid in the closed position such that the enclosure is waterproof.

12. The grounding junction box of claim 11, wherein the lid lock includes a threaded fastener on the lid and a corresponding threaded aperture extending from an outside surface of the at least one side wall.

13. The grounding junction box of claim 11, wherein the lid lock comprises:
a flexible lid lock flange extending from an edge of the lid and including at least one aperture; and
at least one lid lock tab extending from the at least one side wall and configured to engage the at least one aperture.

14. The grounding junction box of claim 1, wherein the wire guide is configured to accommodate grounding wire diameters between 2.5 to 4.2 millimeters.

15. The grounding junction box of claim 1, wherein the at least one side wall extends at an obtuse angle relative to the base wall.

16. The grounding junction box of claim 1, wherein the grounding bar is made of a metal with substantially uniform thickness.

17. The grounding junction box of claim 16, wherein the metal is aluminum.

18. A method for installing grounding junction boxes, the method comprising:
attaching a grounding junction box to a rail, the grounding junction box including a housing, a grounding bar, at least one ground lug, and a rail lock;
electrically bonding the at least one ground lug within the grounding junction box to the grounding bar using a ground lug fastener, wherein the grounding bar is electrically bonded to the rail;
passing a grounding wire into the grounding junction box; and
securing the grounding wire onto the at least one ground lug with the ground lug fastener.
